(19) United States
(12) Patent Application Publication
(10) Pub. No.: US 2015/0234999 A1
(43) Pub. Date: Aug. 20, 2015

(54) SYSTEMS, METHODS AND COMPUTER PROGRAM PRODUCTS FOR DETERMINING A CONSOLIDATED DISEASE RISK SCORE FROM RISK FACTORS AND A LEVEL OF COMPOSITE RISK

(71) Applicant: BioSignia, Inc., Durham, NC (US)

(72) Inventors: Guizhou Hu, Cary, NC (US); Ashlee Duncan, Raleigh, NC (US); Nicholas Williams, Morrisville, NC (US)

(21) Appl. No.: 14/182,664

(22) Filed: Feb. 18, 2014

(51) Int. Cl. G06F 19/00

(52) U.S. Cl. CPC G06F 19/3431

(57) ABSTRACT

Methods, systems and computer program products for assessing a consolidated risk score from two or more risk factors and two or more risk scores are provided. The risk scores include condition-specific composite risk scores based on one or more of the risk factors. One or more of the risk factors are identified as a high risk value factor for a subject. A risk ratio of a combined risk score for a selected subset of the two or more risk scores and a reference combined risk score is determined. A consolidated risk score responsive to the risk ratio and at least one high risk value factor for the subject is assessed.

### FIELD OF THE INVENTION

The present invention relates to systems, methods and computer program products for determining disease risk scores, and more particularly, to consolidated disease risk scores.

### BACKGROUND

An individual's risk for developing chronic disease is typically perceived and assessed from two perspectives: (1) specific, existing risk factors or (2) a level of composite risk. The first approach focuses on a single risk factor, disregarding the presence of other risk factors, while the second perspective focuses on the aggregate impact of multiple risk factors. Although highly correlated, the two approaches are not always consistent. For example, an individual who is overweight (i.e., single risk factor) may always be considered at high risk for developing chronic disease according to the first perspective as a specific risk factor, although his/her composite risk could be well below average due to other factors, such as very low blood pressure and cholesterol, according to the second perspective of composite risk.

The relationship between individual risk and age and gender also varies between the two risk assessment approaches outlined above. Using the single risk factor perspective, risk is usually considered independent of age and gender; however, when assessing the overall, composite risk, age and gender are typically both considered as contributing factors. In clinical practice, a physician uses both approaches—independent risk factors and composite risk—to evaluate an individual's risk, to educate the individual about his/her current risk profile, and to provide appropriate intervention for risk mitigation.

### SUMMARY OF EMBODIMENTS OF THE INVENTION

According to some embodiments, methods, systems and computer program products for assessing a consolidated risk score from two or more risk factors and two or more risk scores are provided. The risk scores include condition-specific composite risk scores based on one or more of the risk factors. One or more of the risk factors are identified as a high risk value factor for a subject. A risk ratio of a combined risk score for a selected subset of the two or more risk scores and a reference combined risk score is determined. A consolidated risk score responsive to the risk ratio and at least one high risk value factor for the subject is assessed.

In some embodiments, the reference combined risk score comprises a combined risk score for a reference individual having an age and gender that is the same as the subject. The reference individual may have a predefined risk factor level for risk factors of the selected subset of the two or more risk scores. The predefined risk factor level may be at an upper limit of a predefined normal range.

In some embodiments, the selected subset of the two or more risk scores comprises risk scores for coronary heart disease, stroke and/or type 2 diabetes.

In some embodiments, the risk score for the selected subset of the two or more risk scores comprises a sum of the risk scores for coronary heart disease, stroke and type 2 diabetes,

In some embodiments, the combined risk score for the selected subset of the two or more risk scores is adjusted responsive to one or more current health behaviors. The one or more current health behaviors may include a current smoking status and/or a past smoking status.

In some embodiments, identifying one or more of the risk factors as a high risk value factor for a subject includes identifying a highest one of the risk factors on a normalized risk scale. The risk ratio may be on the normalized risk scale.

In some embodiments, assessing a consolidated risk score responsive to the risk ratio and the at least one high risk value factor may include determining an average value of a normalized value of the risk ratio and a normalized value of the highest one of the risk factors. In some embodiments, the two or more risk factors are scored on a normalized risk factor scale.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a flowchart illustrating operations according to embodiments of the invention.

FIG. 2 is a schematic diagram of methods, systems and computer program products according to embodiments of the invention.

FIGS. 3-6 are screen shot images illustrating operations according to embodiments of the invention.

### DETAILED DESCRIPTION OF EMBODIMENTS OF THE INVENTION

The present invention now will be described hereinafter with reference to the accompanying drawings and examples, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

As used herein, a “risk factor” is any variable associated with a health outcome or state, such as a risk of disease, infection and/or health-related event, such as a stroke, diabetes, heart attack, cancer and death. Risk factors may be correlated with a health outcome or state and/or have a causal relationship with a health outcome or state.

As used herein, a “risk score” is a measurement of a probability of a health outcome or state. A risk score may be a composite risk that is calculated from one or more risk factors, and may include contributing factors, such as age and gender. A condition-specific risk score may include a probability measurement of the patient acquiring a specific condition. The probability measurement may be an actual or a relative probability, and may be normalized, for example, in a one hundred point scale.

As used herein, a “consolidated risk score” is a risk score that combines information from existing risk factors and a level of composite risk. The consolidated risk score may be a measurement of overall health on a predefined scale, and may be independent of age and/or gender.

According to some embodiments, systems, methods and computer program products are provided for assessing a consolidated risk score from two or more risk factors and two or more risk scores. The risk scores include condition-specific composite risk scores based on one or more of the risk factors.

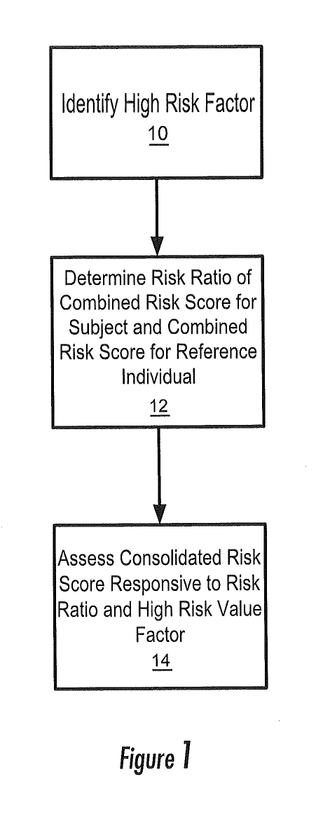

FIG. 1 is a flowchart illustrating operations according to some embodiments. As illustrated in FIG. 1, one or more of the risk factors is identified as a high risk value factor for a subject (Block 10). A risk ratio of a combined risk score for a selected subset of the two or more risk scores and a reference combined risk score is determined (Block 12). A consolidated risk score is assessed responsive to the risk ratio and at least one high risk value factor for the subject (Block 14).

The high risk value factor that is identified at Block 10 may be a risk factor that has the highest relative value. For example, a plurality of risk values for a patient may be evaluated on a uniform or normalized scale with a linear extrapolation. The uniform scale of the risk value may be based on standard risk value scales, such as those issued by government agencies such as the National Institutes of Health, or the risk value uniform scale may be determined by any suitable method, including a linear extrapolation on a uniform scale between typical high and low values. An example of a uniform 100-point scale is as follows:

a. 0-20 very low (optimal)

b. 21-40 normal

c. 41-60 slightly high

d. 61-80 high

e. 81-100 very high

f. >100 extremely high

For example, according to the Adult Treatment Protocol III (ATP III), the risk classification for total cholesterol, when converted to a uniform risk scale, may be scored as follows with other values scored through a linear extrapolation as would be understood by those of skill in the art:

150 mg/dL scored as 20

200 mg/dL scored as 40

240 mg/dL scored as 60

300 mg/dL scored as 80

When all risk factors are evaluated on a uniform scale, the highest risk value of the risk factors may be used to identify the risk factor with the highest score at Block 10. Although a 100-point scale is described herein, it should be understood that any uniform scale or scale that allows a comparison of risk may be used.

The risk ratio, which is calculated at Block 12, may be determined from a risk ratio of a combined risk score for a selected subset of the two or more risk scores and a reference combined risk score. For example, a selected subset of two or more risk scores may be risk scores that have a relatively high impact on the patient's overall heath. In particular embodiments, the selected subset of two or more risk scores includes risk scores for two or more of the following conditions: coronary heart disease, stroke and type-2 diabetes. The risk scores for a particular condition or disease may be determined using techniques known to those of skill in the art, and may be determined as described, for example, in U.S. Pat. No. 6,110,109 to Hu et al., the disclosure of which is incorporated by reference in its entirety.

In particular embodiments, the risk score for a particular condition is a probability of developing the condition over a period of time, such as over one year, five years or ten years. The risk scores of each of the selected conditions (e.g., coronary heart disease, stroke and type-2 diabetes) may be summed to provide the composite risk score. For example, if an individual's five year risk estimates for developing chronic heart disease, stroke and diabetes are 0,025, 0.01 and 0.03, respectively, then the composite risk score for these conditions is 0.065. If the individual has a history of having a condition, such as coronary heart disease, stroke or type-2 diabetes, then the risk estimates may include a risk of developing complications or having other health events caused by or related to the condition. For example, if an individual has type-2 diabetes, he or she may have a five year risk estimate for developing complications or other diabetes-related health events of about 26% on average. If an individual has a history of coronary heart disease or stroke, the risk for developing complications or other cardiovascular health events, such as a coronary blockage or another stroke, is about 20% on average for coronary heart disease and about 13% on average for stroke.

The combined risk score for the selected subset of the two or more risk scores may be further adjusted responsive to one or more current health behaviors. For example, the combined risk score may be increased for particularly harmful behavior that increases a patient's risk, and the combined risk score may be decreased for particularly beneficial behavior. This adjustment may be used, for example, when the impact of certain health behaviors may not be fully captured in the combined risk score. For example, the impact of smoking on overall health may extend beyond its impact on the risk of heart disease, stroke and diabetes only. Under such conditions, the combined risk score may be increased for a current smoker. In some embodiments, the combined risk score for the patient may be increased by about 100%±20% for current smokers and by about 30%±10% for past smokers.

The reference combined risk score may include a combined risk score for a hypothetical reference individual having an age and gender that is the same as the subject, and the reference individual may have a predefined risk factor level for risk factors of the selected subset of the two or more risk scores. Stated otherwise, the reference individual has all risk modifiable factors (e.g., BMI, blood pressure, glucose levels, etc.) at a predetermined level. Any suitable predefined risk factor level may be used; however, in some embodiments, the predefined risk factor level is at an upper limit of a normal range. For example, the reference individual for a 40-year old male has a blood pressure of 119/79 mmHg, a BMI of 24.9, a total cholesterol of 199 mg/dL, an HDL of 41 mg/dL, a glucose of 99 mg/dL, and has never smoked; additionally, the reference individual has no non-modifiable risk, such as a family history of disease. The combined disease risk for the reference individual is 0.055.

The risk ratio calculated in Block 12 is the ratio between the assessed individual risk score and the reference individual risk score. In some embodiments, the reference individual is matched to the assessed individual by age and gender, and therefore, the risk ratio is independent of the risk attributed by age and gender. The risk ratio may also be converted to a normalized risk scale, for example, by applying a natural log transformation to the ratio to make the distribution of the ratio closer to normal in a general population. In some embodiments, the risk ratio may be calibrated to a uniform composite risk scale, e.g., by calibrating the ratio to a uniform or standard scale, such as a 100-point scale.

For example, the risk ratio may be calibrated to a uniform composite risk scale as follows:
log (risk ratio=0.15) is scored as a composite risk of 1
Every 0.05-unit increase in the log(risk ratio) results in a 1-unit increase in the composite risk scale

The consolidated risk score may be assessed responsive to the risk ratio and the at least one high risk value factor at Block 14 by determining an average value of the risk ratio (from Block 12) and the highest one of the risk factors (Block 10). In some embodiments, the risk ratio and the highest one of the risk factors are both on a normalized scale for ease of comparison.

Accordingly, a risk assessment is provided that may integrate both a risk factor approach and a composite risk approach. In some embodiments, a single risk measurement or value is provided that integrates the risk factors and the composite risk of an individual, and the consolidated risk score may be independent of gender and age. The risk assessment described herein may be repeated over time in order to provide a gender- and age-independent evaluation of health for an individual. In some embodiments, particular health recommendations may be generated in response to the consolidated risk score for the individual. The consolidated risk score may also be used to determine risk, for example, as applied to incentivizing participation in employer wellness programs, stratifying for workplace wellness competitions, establishing health insurance subsidies, forecasting risk for life insurance and/or health insurance and the like.

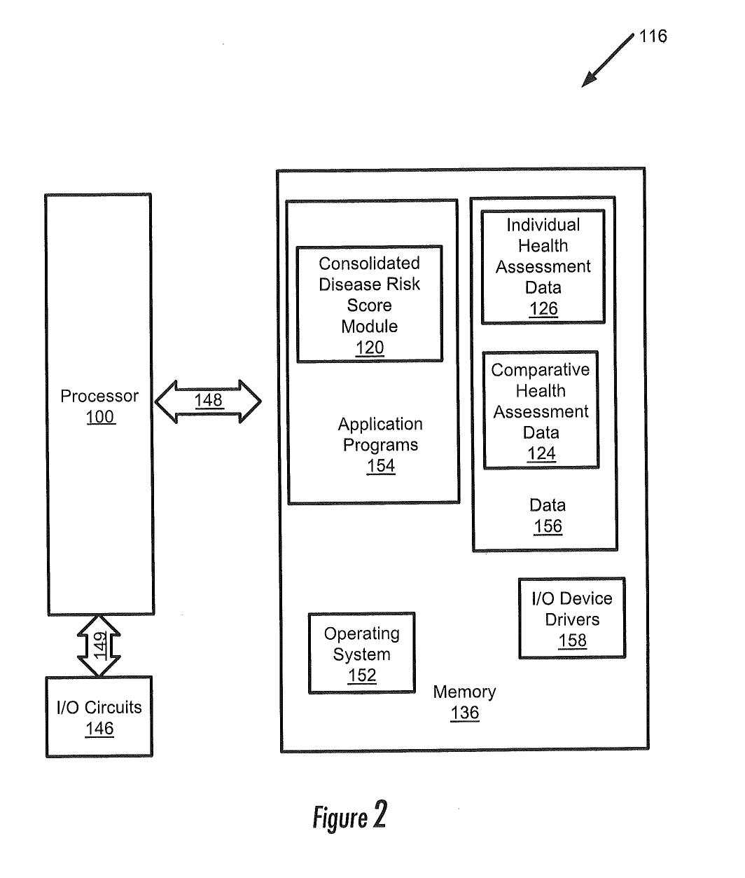

FIG. 2 illustrates an exemplary data processing system that may be included in devices operating in accordance with some embodiments of the present invention, e.g., to carry out the operations illustrated in FIG. 1 and described herein. As illustrated in FIG. 2, a data processing system 116, which can be used to carry out or direct operations includes a processor 100, a memory 136 and input/output circuits 146. The data processing system can be incorporated in a portable communication device and/or other components of a network, such as a server. The processor 100 communicates with the memory 136 via an address/data bus 148 and communicates with the input/output circuits 146 via an address/data bus 149. The input/output circuits 146 can be used to transfer information between the memory (memory and/or storage media) 136 and another component, such as a processor, health records database, or a data acquisition device for collecting health related data, such as a device for determining an individual's blood pressure, a scale for registering the individual's weight, a device for collecting information about a blood, urine or other sample from the individual. These components can be conventional components such as those used in many conventional data processing systems, which can be configured to operate as described herein.

In particular, the processor 100 can be a commercially available or custom microprocessor, microcontroller, digital signal processor or the like. The memory 136 can include any memory devices and/or storage media containing the software and data used to implement the functionality of circuits or modules used in accordance with embodiments of the present invention. The memory 136 can include, but is not limited to, the following types of devices: cache, ROM, PROM, EPROM, EEPROM, flash memory, SRAM, DRAM and magnetic disk. In some embodiments of the present invention, the memory 136 can be a content addressable memory (CAM).

As further illustrated in FIG. 2, the memory (and/or storage media) 136 can include several categories of software and data used in the data processing system: an operating system 152; application programs 154; input/output device drivers 158; and data 156. As will be appreciated by those of skill in the art, the operating system 152 can be any operating system suitable for use with a data processing system, such as IBM®, OS/2®, AIX® or zOS® operating systems, Microsoft® Windows® operating systems, Android®, Unix or Linux™. The input/output device drivers 158 typically include software routines accessed through the operating system 152 by the application programs 154 to communicate with various devices. The application programs 154 are illustrative of the programs that implement the various features of the circuits and modules according to some embodiments of the present invention. Finally, the data 156 represents the static and dynamic data used by the application programs 154, the operating system 152 the input/output device drivers 158 and other software programs that can reside in the memory 136.

The data processing system 116 can include several modules, including a consolidated disease risk score module 120 and the like. The modules can be configured as a single module or additional modules otherwise configured to implement the operations described herein for determining a consolidated disease risk score. The data 156 can include comparative health assessment data 124, such as relevant normalized risk scales, reference individual scores, and the like, and/or individual health assessment data 126, such as health metrics for an individual. The data 124, 126 may include any data or calculations that may be used by the consolidated disease risk score module 120 to determine the consolidated disease risk score as described herein.

While the present invention is illustrated with reference to the consolidated disease risk score module 120, the comparative health assessment data 124, and individual health assessment data 126 in FIG. 2, as will be appreciated by those of skill in the art, other configurations fall within the scope of the present invention. For example, rather than being an application program 154, these circuits and modules can also be incorporated into the operating system 152 or other such logical division of the data processing system. Furthermore, while the consolidated disease risk score module 120 in FIG. 2 is illustrated in a single data processing system, as will be appreciated by those of skill in the art, such functionality can be distributed across one or more data processing systems. Thus, the present invention should not be construed as limited to the configurations illustrated in FIG. 2, but can be provided by other arrangements and/or divisions of functions between data processing systems. For example, although FIG. 2 is illustrated as having various circuits and modules, one or more of these circuits or modules can be combined, or separated further, without departing from the scope of the present invention. The consolidated disease risk score module 120 may be configured to calculate a consolidated disease risk score as described herein and to generate a report of the consolidated disease risk score.

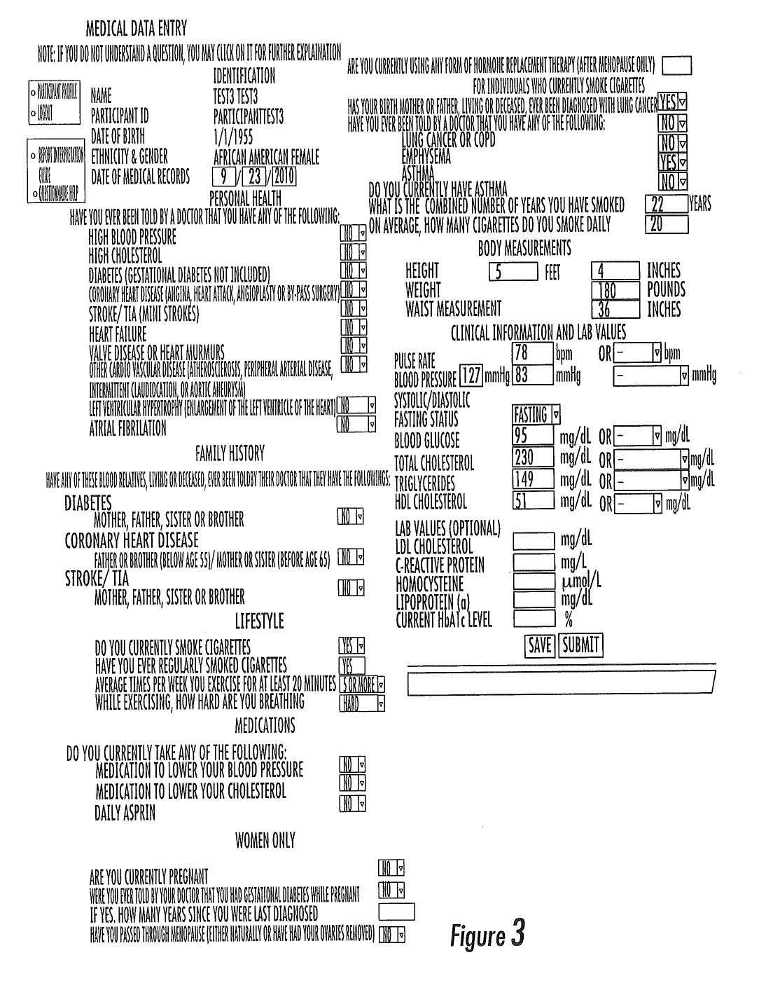

Embodiments according to the present invention will now be described with respect to the following non-limiting example. In this example, the participant is a 58-year-old African American female. Below are her values for each element for generating a consolidated risk score. An exemplary data entry screen shot is illustrated in FIG. 3.
1. Age: 58 years
2. Gender: female
3. Combined 5-year current risk of CHD, stroke, and diabetes from the RISK TRACKER models: CHD=7.8%; Stroke=3%; Diabetes=11%→total=21.8%
4. BMI: 31.8
5. Waist circumference: 38 inches
6. Total cholesterol: 249 mg/dL
7. LDL cholesterol: 174 mg/dL
8. Triglycerides: 149 mg/dL
9. HDL cholesterol: 45 mg/dL
10. Exercise intensity: moderate
11. Exercise frequency: moderate
12. Fasting glucose: 98 mg/dL
13. Systolic blood pressure: 130 mmHg
14. Diastolic blood pressure: 85 mmHg
15. Current smoker: yes
16. Past smoker: yes (automatic YES if a current smoker)
17. History of CHD: no
18. History of stroke: no
19. History of diabetes: no
20. On blood pressure medication: no
21. On lipid medication: no

In order to determine the highest risk value factor for the subject (Block 10; FIG. 1), each individual risk factor is scored based on a uniform, standard-of-care guideline-derived categorical scale with linear extrapolation applied between the thresholds.
a. BMI→The example participant has a BMI of 31.8, which is above the obese threshold. She receives a BMI score of 67.
b. Waist circumference→The example participant has a waist measurement of 38 inches or beyond normal (35 inches in females). Using the regression equation to yield an “alternate BMI” of 30.04, she receives a score of 60.2 for her waist circumference.
c. Total cholesterol→The example participant has a total cholesterol of 249 mg/dL, categorized as high according to the ATPIII guideline; she receives a score of 63.
d. LDL cholesterol→The example participant has an LDL cholesterol of 174 mg/dL; she receives a score of 69 for this risk factor.
e. Triglycerides→The example participant has a triglyceride level of 149 mg/dL, categorized as normal according to the ATPIII guideline; she receives a score of 39.
f. HDL cholesterol→The example participant has an HDL cholesterol of 45 mg/dL and receives a score of 46.7.
g. Exercise→The participant reported moderate exercise frequency and intensity, yielding a score of 40.
h. Glucose→The participant had a fasting glucose level of 96 mg/dL, which is normal according to the American Diabetes Association; she received a score of 0 for this risk factor.
i. Blood pressure→The participant reported a systolic blood pressure (SBP) of 130 and a diastolic blood pressure (DBP) of 85 mmHg. An equivalent SBP (SBP_e) using the DBP may be calculated using the formula SBP_e=120+(DPB-80)*2. The SBP_e was subsequently compared to the participant-reported SBP, and the higher value (SBP_m or maximum=130) was used to derive a risk factor score of 50.
j. Smoking→The example participant is a current smoker, and therefore, received a score of 80.
k. Disease history→The participant reported no history of CHD, stroke, or diabetes, resulting in a score of 0.
l. Medication history→The participant reported no current use of medications for high blood pressure or high cholesterol, resulting in a score of 0.

According to Block 10 of FIG. 1, the risk factor that yielded the highest score is determined. In the case of the example participant, her status as a current smoker generated the highest risk factor score (80). This value is the first of two elements used to calculate the Risk Tracker score.

The combined risk score (Block 12 of FIG. 1) is determined as follows:
a. The example participant's RISK TRACKER 5-year absolute risk for three diseases (CHD=7.8%; stroke=3%; diabetes=11% for a combined risk of 21.8%) is determined.
b. Because the example participant is a current smoker, her combined disease risk is increased by 100%, yielding a smoking-adjusted combined disease risk of 43.6%.
c. The combined disease risk for a pre-calculated reference individual (see Table below) who matches the example by age and gender, but has all modifiable risk factors at the upper limit of normal is determined as follows:
   1. Age: 58 years
   2. Gender: female
   3. BMI: 24.9
   4. Waist circumference: 34.9 inches
   5. Total cholesterol: 199 mg/dL
   6. LDL cholesterol: 99 mg/dL
   7. Triglycerides: 149 mg/dL (example at top of normal)
   8. HDL cholesterol: 51 mg/dL
   9. Exercise intensity: high
   10. Exercise frequency: high
   11. Fasting glucose: 98 mg/dL (example lower than top of normal, which is 99 mg/dL)
   12. Systolic blood pressure: 119 mmHg
   13. Diastolic blood pressure: 79 mmHg
   14. Current smoker: no
   15. Past smoker: no
   16. History of CHD: no
   17. History of stroke: no
   18. History of diabetes: no
   19. On blood pressure medication: no
   20. On lipid medication: no

| | Male | Female |
|---|---|---|
| Age | reference | reference |
| 21 | 0.006187 | 0.003633 |
| 22 | 0.006599 | 0.003789 |
| 23 | 0.007067 | 0.003962 |
| 24 | 0.007597 | 0.004156 |
| 25 | 0.008192 | 0.004374 |
| 26 | 0.008856 | 0.004619 |
| 27 | 0.009593 | 0.004899 |
| 28 | 0.010408 | 0.005222 |
| 29 | 0.011304 | 0.005597 |
| 30 | 0.012284 | 0.006035 |
| 31 | 0.013352 | 0.006545 |
| 32 | 0.01451 | 0.007139 |
| 33 | 0.015761 | 0.007826 |
| 34 | 0.017107 | 0.008614 |
| 35 | 0.018551 | 0.009508 |
| 36 | 0.020092 | 0.010511 |
| 37 | 0.021733 | 0.011626 |
| 38 | 0.023473 | 0.012851 |
| 39 | 0.025312 | 0.014182 |
| 40 | 0.02725 | 0.015613 |
| 41 | 0.029284 | 0.017138 |
| 42 | 0.031411 | 0.018747 |
| 43 | 0.03363 | 0.02043 |
| 44 | 0.035934 | 0.022175 |
| 45 | 0.03832 | 0.02397 |
| 46 | 0.040781 | 0.0258 |
| 47 | 0.04331 | 0.027653 |
| 48 | 0.0459 | 0.029513 |
| 49 | 0.048543 | 0.031367 |
| 50 | 0.051228 | 0.033199 |
| 51 | 0.053946 | 0.034995 |
| 52 | 0.056688 | 0.03674 |
| 53 | 0.059441 | 0.038422 |
| 54 | 0.062197 | 0.040026 |
| 55 | 0.064945 | 0.041542 |
| 56 | 0.067676 | 0.042957 |
| 57 | 0.070379 | 0.044261 |
| 58 | 0.073049 | 0.045448 |
| 59 | 0.075678 | 0.04651 |
| 60 | 0.078263 | 0.047443 |
| 61 | 0.080799 | 0.048244 |
| 62 | 0.083287 | 0.048914 |
| 63 | 0.08573 | 0.049455 |
| 64 | 0.088129 | 0.049871 |
| 65 | 0.090494 | 0.050171 |
| 66 | 0.092831 | 0.050362 |
| 67 | 0.095152 | 0.050456 |
| 68 | 0.09747 | 0.050467 |
| 69 | 0.0998 | 0.05041 |
| 70 | 0.102156 | 0.050301 |
| 71 | 0.104556 | 0.050156 |
| 72 | 0.107015 | 0.049995 |
| 73 | 0.109551 | 0.049833 |
| 74 | 0.112179 | 0.049688 |
| 75 | 0.114913 | 0.049578 |
| 76 | 0.117768 | 0.049518 |
| 77 | 0.120756 | 0.049522 |
| 78 | 0.123885 | 0.049604 |
| 79 | 0.127165 | 0.049776 |
| 80 | 0.130602 | 0.050048 |

The combined disease risk for the reference individual is 0.045448 or 4.5448%. The risk ratio is calculated by dividing the combined disease risk for the example participant (43.6%) by the combined disease risk for the reference (4.54%), generating a risk ratio of 9.59. Using a table of pre-calculated (natural) log transformed risk ratios and their corresponding, calibrated scores (provided in the table below), the risk ratio of 9.59 is used to determine the participant's composite risk score of 84.

| Risk ratio | Score |
|---|---|
| 0.15 | 1 |
| 0.16 | 2 |
| 0.17 | 3 |
| 0.17 | 4 |
| 0.18 | 5 |
| 0.19 | 6 |
| 0.20 | 7 |
| 0.21 | 8 |
| 0.22 | 9 |
| 0.24 | 10 |
| 0.25 | 11 |
| 0.26 | 12 |
| 0.27 | 13 |
| 0.29 | 14 |
| 0.30 | 15 |
| 0.32 | 16 |
| 0.33 | 17 |
| 0.35 | 18 |
| 0.37 | 19 |
| 0.39 | 20 |
| 0.41 | 21 |
| 0.43 | 22 |
| 0.45 | 23 |
| 0.47 | 24 |
| 0.50 | 25 |
| 0.52 | 26 |
| 0.55 | 27 |
| 0.58 | 28 |
| 0.61 | 29 |
| 0.64 | 30 |
| 0.67 | 31 |
| 0.71 | 32 |
| 0.74 | 33 |
| 0.78 | 34 |
| 0.82 | 35 |
| 0.86 | 36 |
| 0.91 | 37 |
| 0.95 | 38 |
| 1.00 | 39 |
| 1.05 | 40 |
| 1.11 | 41 |
| 1.17 | 42 |
| 1.22 | 43 |
| 1.29 | 44 |
| 1.35 | 45 |
| 1.42 | 46 |
| 1.50 | 47 |
| 1.57 | 48 |
| 1.65 | 49 |
| 1.74 | 50 |
| 1.83 | 51 |
| 1.92 | 52 |
| 2.02 | 53 |
| 2.12 | 54 |
| 2.23 | 55 |
| 2.35 | 56 |
| 2.47 | 57 |
| 2.59 | 58 |
| 2.73 | 59 |
| 2.87 | 60 |
| 3.01 | 61 |
| 3.17 | 62 |
| 3.33 | 63 |
| 3.50 | 64 |
| 3.68 | 65 |
| 3.87 | 66 |
| 4.07 | 67 |
| 4.28 | 68 |
| 4.49 | 69 |
| 4.73 | 70 |
| 4.97 | 71 |
| 5.22 | 72 |
| 5.49 | 73 |
| 5.77 | 74 |
| 6.07 | 75 |
| 6.38 | 76 |
| 6.71 | 77 |
| 7.05 | 78 |
| 7.41 | 79 |
| 7.79 | 80 |
| 8.19 | 81 |
| 8.61 | 82 |
| 9.05 | 83 |
| 9.52 | 84 |
| 10.00 | 85 |
| 10.52 | 86 |
| 11.05 | 87 |
| 11.62 | 88 |
| 12.22 | 89 |
| 12.84 | 90 |
| 13.50 | 91 |
| 14.19 | 92 |
| 14.92 | 93 |
| 15.69 | 94 |
| 16.49 | 95 |
| 17.34 | 96 |
| 18.23 | 97 |
| 19.16 | 98 |
| 20.14 | 99 |
| 21.18 | 100 |
| 22.26 | 101 |
| 23.40 | 102 |
| 24.60 | 103 |
| 25.86 | 104 |
| 27.19 | 105 |
| 28.58 | 106 |
| 30.05 | 107 |
| 31.59 | 108 |
| 33.21 | 109 |
| 34.91 | 110 |
| 36.70 | 111 |
| 38.59 | 112 |
| 40.56 | 113 |
| 42.64 | 114 |
| 44.83 | 115 |
| 47.13 | 116 |
| 49.54 | 117 |
| 52.09 | 118 |
| 54.76 | 119 |
| 57.56 | 120 |
| 60.51 | 121 |
| 63.62 | 122 |
| 66.88 | 123 |
| 70.31 | 124 |
| 73.91 | 125 |
| 77.70 | 126 |
| 81.69 | 127 |
| 85.87 | 128 |
| 90.28 | 129 |
| 94.91 | 130 |
| 99.77 | 131 |
| 104.89 | 132 |
| 110.26 | 133 |
| 115.92 | 134 |
| 121.86 | 135 |
| 128.11 | 136 |
| 134.68 | 137 |
| 141.58 | 138 |
| 148.84 | 139 |
| 156.47 | 140 |
| 164.49 | 141 |
| 172.93 | 142 |
| 181.80 | 143 |
| 191.12 | 144 |
| 200.91 | 145 |
| 211.22 | 146 |
| 222.04 | 147 |
| 233.43 | 148 |
| 245.40 | 149 |
| 257.98 | 150 |
| 271.21 | 151 |
| 285.11 | 152 |
| 299.73 | 153 |
| 315.10 | 154 |
| 331.25 | 155 |
| 348.24 | 156 |
| 366.09 | 157 |
| 384.86 | 158 |
| 404.59 | 159 |
| 425.34 | 160 |
| 447.14 | 161 |
| 470.07 | 162 |
| 494.17 | 163 |
| 519.51 | 164 |
| 546.14 | 165 |
| 574.14 | 166 |
| 603.58 | 167 |
| 634.53 | 168 |
| 667.06 | 169 |
| 701.26 | 170 |
| 737.22 | 171 |
| 775.01 | 172 |
| 814.75 | 173 |
| 856.52 | 174 |
| 900.44 | 175 |

The participant's composite risk score of 84 and her maximum risk factor score of 80 are then averaged to yield her consolidated risk score of 82.

In some embodiments, the consolidated risk score may be calculated for the same individual over time to assess changes in health. The following example uses the same patient described above, but in 2010 when she is 55 years old. Below are her values for each element for the consolidated risk score:
Age: 55 years
Gender: female
Combined 5-year current risk of CHD, stroke, and diabetes=4.5%, 2.4%, and 7%→total=13.9%
BMI: 30.9
Waist circumference: 36 inches
Total cholesterol: 230 mg/dL
LDL cholesterol: 149 mg/dL
Triglycerides: 149 mg/dL
HDL cholesterol: 51 mg/dL
Exercise intensity: high
Exercise frequency: high
Fasting glucose: 95 mg/dL
Systolic blood pressure: 127 mmHg
Diastolic blood pressure: 83 mmHg
Current smoker: yes
Past smoker: yes (automatic YES if a current smoker)
History of CHID: no
History of stroke: no
History of diabetes: no
On blood pressure medication: no
On lipid medication: no
Risk factor scores were as follows:
   BMI→64
   Waist circumference→alternate BMI=28.04; score=52.15
   Total cholesterol→55
   LDL cholesterol→56
   Triglycerides→39
   HDL cholesterol→0
   Exercise→0
   Glucose→0
   Blood pressure→SBP_e=126; SBP_m=127; score=47
   Smoking→80
   Disease history→0
   Medication history→0

Maximum risk factor score=80
Combined risk and risk ratio calculations were as follows:
   Total 5-year risk for three diseases (CHD=4.5%; stroke=2.4%; diabetes=7%)=13.9%
   Smoking adjustment→27.8%
   Combined disease risk for reference individual=0.0415416 or 4.15416%
   Risk ratio=6.69

Composite risk score=76

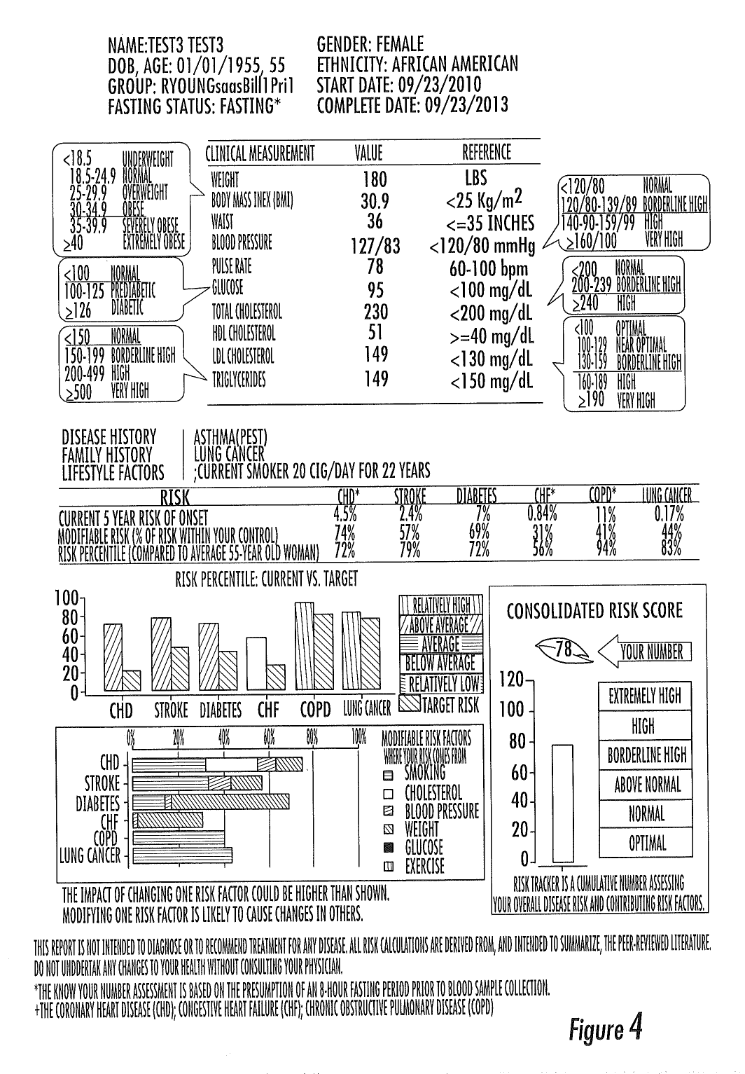

The participant's composite risk score of 76 and her maximum risk factor score of 80 are then averaged to yield her consolidated risk score of 78. FIG. 4 illustrates an exemplary report that may be generated for the individual that highlights particular risks and provides the consolidated risk score.

Again using the same participant, a profile dated to 2015 was generated, in which the participant is now 60 years old, has stopped smoking, and is on medication for high blood pressure and high cholesterol. Below are her values for each element for the consolidated risk score:
Age: 60 years
Gender: female
Combined 5-year current risk of CHD, stroke, and diabetes=2.1%, 1.4%, and 4.3%→total=7.8%
BMI: 27.5
Waist circumference: 34 inches
Total cholesterol: 211 mg/dL
LDL cholesterol: 134 mg/dL
Triglycerides: 149 mg/dL
HDL cholesterol: 47 mg/dL
Exercise intensity: moderate
Exercise frequency: moderate
Fasting glucose: 99 mg/dL
Systolic blood pressure: 121 mmHg
Diastolic blood pressure: 78 mmHg
Current smoker: no
Past smoker: yes
History of CHD: no
History of stroke: no
History of diabetes: no
On blood pressure medication: yes
On lipid medication: yes
Risk factor scores were as follows:
   BMI→50
   Waist circumference→alternate BMI=26.03; score=0
   Total cholesterol→46
   LDL cholesterol→51
   Triglycerides→39
   HDL cholesterol→44
   Exercise→40
   Glucose→0
   Blood pressure→SBP_e=116; SBP_m=121; score=41
   Smoking→40
   Disease history→0
   Medication history→60

Maximum risk factor score=60
Combined risk and risk ratio calculations were as follows:
   Total Risk Tracker 5-year risk for three diseases (CHD=2.1%; stroke=1.4%; diabetes=4.3%)=7.8%
   Smoking adjustment→10.14%
   Combined disease risk for reference individual=0.04744291 or 4.744291%
   Risk ratio=2.14

Composite risk score=54

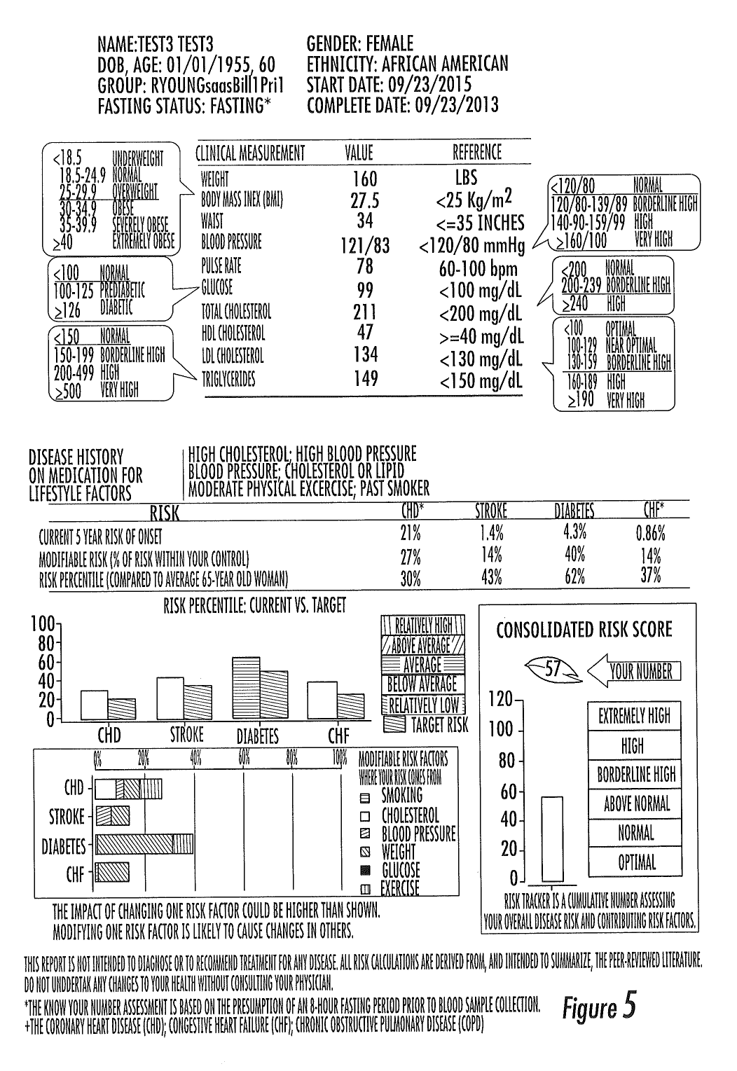

The participant's composite risk score of 54 and her maximum risk factor score of 60 are then averaged to yield her consolidated risk score of 57. An exemplary summary report is shown in FIG. 5.

In the next example taken in 2020, the participant is now 65 years old. No additional changes were made to her risk profile, but the change in age only is reflected (albeit minor) in her consolidated risk score estimates. Below are her values for each element for the consolidated risk score:
Age: 65 years
Gender: female
Combined 5-year current risk of CHD, stroke, and diabetes=2.3%, 1.7%, and 3.8%→total=7.8%
   All other parameters, and their corresponding risk factor scores, are the same as in the 2015 profile.

Maximum risk factor score=60
Combined risk and risk ratio calculations were as follows:
   Total Risk Tracker 5-year risk for three diseases (CHD=2.3%; stroke=1.7%; diabetes=3.8%)=7.8%
   Smoking adjustment→10.14%
   Combined disease risk for reference individual=0.05017051 or 5.017051%
   Risk ratio=2.02

Composite risk score=53

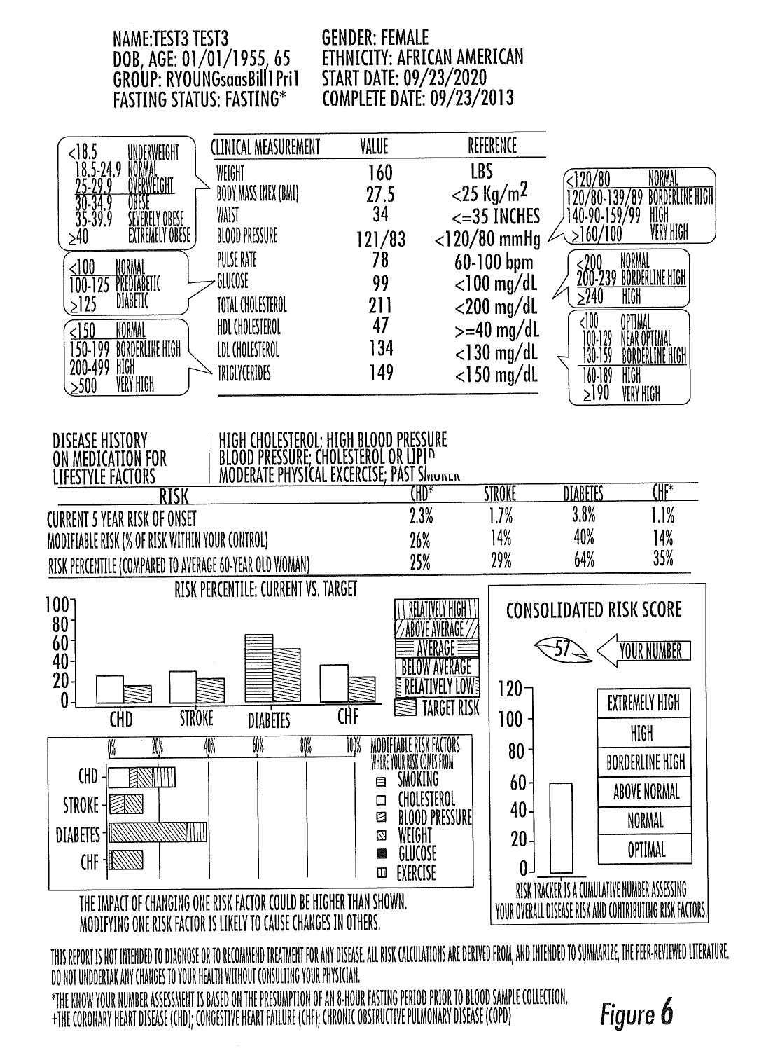

The participant's composite risk score of 53 and her maximum risk factor score of 60 are then averaged to yield her consolidated risk score of 57. FIG. 6 illustrates an exemplary report that may be generated for the individual that highlights particular risks and provides the consolidated risk score.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method for assessing a consolidated risk score from two or more risk factors and two or more risk scores, wherein the risk scores comprise condition-specific composite risk scores based on one or more of the risk factors, the method comprising:
identifying one or more of the risk factors as a high risk value factor for a subject;
determining a risk ratio of a combined risk score for a selected subset of the two or more risk scores and a reference combined risk score; and
assessing a consolidated risk score responsive to the risk ratio and at least one high risk value factor for the subject.

2. The method of claim 1, wherein the reference combined risk score comprises a combined risk score for a reference individual having an age and gender that is the same as the subject.

3. The method of claim 2, wherein the reference individual has a predefined risk factor level for risk factors of the selected subset of the two or more risk scores.

4. The method of claim 3, wherein the predefined risk factor level is at an upper limit of a predefined normal range.

5. The method of claim 1, wherein the selected subset of the two or more risk scores comprises risk scores for coronary heart disease, stroke and/or type 2 diabetes.

6. The method of claim 1, wherein the risk score for the selected subset of the two or more risk scores comprises a sum of the risk scores for coronary heart disease, stroke and type 2 diabetes.

7. The method of claim 1, wherein the combined risk score for the selected subset of the two or more risk scores is adjusted responsive to one or more current health behaviors.

8. The method of claim 7, wherein the one or more current health behaviors comprises a current smoking status and/or a past smoking status.

9. The method of claim 1, wherein identifying one or more of the risk factors as a high risk value factor for a subject comprises identifying a highest one of the risk factors on a normalized risk scale.

10. The method of claim 1, wherein the risk ratio is on the normalized risk scale.

11. The method of claim 1, wherein assessing a consolidated risk score responsive to the risk ratio and the at least one high risk value factor comprises an average value of a normalized value of the risk ratio and a normalized value of the highest one of the risk factors.

12. The method of claim 1, wherein the two or more risk factors are scored on a normalized risk factor scale.

13. A system for assessing a consolidated risk score from two or more risk factors and two or more risk scores, wherein the risk scores comprise condition-specific composite risk scores based on one or more of the risk factors, the system comprising:
a consolidated disease score risk module that is configured to identify one or more of the risk factors as a high risk value factor for a subject, to determine a risk ratio of a combined risk score for a selected subset of the two or more risk scores and a reference combined risk score; and to assess a consolidated risk score responsive to the risk ratio and at least one high risk value factor for the subject.

14. The system of claim 13, wherein the reference combined risk score comprises a combined risk score for a reference individual having an age and gender that is the same as the subject.

15. The system of claim 14, wherein the reference individual has a predefined risk factor level for risk factors of the selected subset of the two or more risk scores.

16. The system of claim 15, wherein the predefined risk factor level is at an upper limit of a predefined normal range.

17. The system of claim 13, wherein the selected subset of the two or more risk scores comprises risk scores for coronary heart disease, stroke and/or type 2 diabetes.

18. The system of claim 13, wherein the risk score for the selected subset of the two or more risk scores comprises a sum of the risk scores for coronary heart disease, stroke and type 2 diabetes.

19. The system of claim 13, wherein the combined risk score for the selected subset of the two or more risk scores is adjusted responsive to one or more current health behaviors.

20. The system of claim 19, wherein the one or more current health behaviors comprises a current smoking status and/or a past smoking status.

21. The system of claim 13, wherein the consolidated disease score risk module is configured to identify one or more of the risk factors as a high risk value factor for a subject comprises by identifying a highest one of the risk factors on a normalized risk scale.

22. The system of claim 13, wherein the risk ratio is on the normalized risk scale.

23. The system of claim 13, wherein the consolidated disease score risk module is configured to assess a consolidated risk score responsive to the risk ratio and the at least one high risk value factor by determining an average value of a normalized value of the risk ratio and a normalized value of the highest one of the risk factors.

24. The system of claim 13, wherein the two or more risk factors are scored on a normalized risk factor scale.

25. A computer program product for assessing a consolidated risk score from two or more risk factors and two or more risk scores, wherein the risk scores comprise condition-specific composite risk scores based on one or more of the risk factors, the computer program product comprising a non-transient computer readable medium having computer readable program code embodied therein, the computer readable program code comprising:
computer readable program code that is configured to identify one or more of the risk factors as a high risk value factor for a subject;
computer readable program code that is configured to determine a risk ratio of a combined risk score for a selected subset of the two or more risk scores and a reference combined risk score; and
computer readable program code that is configured to assess a consolidated risk score responsive to the risk ratio and at least one high risk value factor for the subject.
